(19) United States
(12) Patent Application Publication
(10) Pub. No.: US 2026/0296376 A1
(43) Pub. Date: Oct. 1, 2026

(54) VEHICLE AND TRIM INCLUDING CAMERA AND WASHING SYSTEM IN WHEEL ARCH

(71) Applicant: Honda Motor Co., Ltd., Tokyo (JP)

(72) Inventors: Karthikeyan MANIYARASAN, Marysville, OH (US); Steven M. KOVACH, Dublin, OH (US); Jonathan A. RIHTAR, Columbus, OH (US); Shinichi OKUNISHI, Saitama (JP); David N. BUSCH, Marysville, OH (US)

(21) Appl. No.: 19/096,561

(22) Filed: Mar. 31, 2025

(51) Int. Cl. B60S 1/56; B60R 11/04; B60S 1/48; B60S 1/52; B62D 25/16; G02B 27/00; B60R 11/00

(52) U.S. Cl. CPC B60S 1/56; B60R 11/04; B60S 1/485; B60S 1/52; B62D 25/161; G02B 27/0006; B60R 2011/004

(57) ABSTRACT

A vehicle and vehicle trim are disclosed in which the vehicle a front wheel and a rear wheel spaced from the front wheel along a longitudinal direction of the vehicle, the front wheel having a rotational axis and the rear wheel having a rotational axis. A fender can define a wheel arch adjacent a wheel and extend around a portion of the rotational axis of the wheel. A trim piece can be connected to the fender along the wheel arch, the trim piece extending about the wheel arch from a location in front of the wheel rotational axis in the longitudinal direction to a location behind the wheel rotational axis in the longitudinal direction. A camera can be located on the trim piece and a spray nozzle can be located adjacent the camera on the trim piece.

### BACKGROUND

The disclosed subject matter relates to a vehicle and vehicle trim including a camera system for supporting various levels of autonomous driving. More particularly, the disclosed subject matter relates to a vehicle and trim that includes a camera and wash system for supporting autonomous driving.

Vehicle systems for supporting autonomous driving can include both a camera and a washing system such as a spray nozzle, pump, and fluid reservoir. However, it has been difficult to adequately position both the camera(s) and washing system(s) to provide a proper view of space surrounding the vehicle while allowing for improved aerodynamic and aesthetic characteristics for the vehicle.

### SUMMARY

Some embodiments are directed to a vehicle having a camera and wash system. The vehicle can have a longitudinal direction and a transverse direction perpendicular to the longitudinal direction of the vehicle, the vehicle including a front wheel and a rear wheel spaced from the front wheel along the longitudinal direction of the vehicle, the front wheel having a rotational axis and the rear wheel having a rotational axis. A front fender can define a front wheel arch adjacent the front wheel and extending around a portion of the rotational axis of the front wheel. A front arcuate trim piece can be connected to the front fender along the front wheel arch, the trim piece extending about the front wheel arch from a location in front of the front wheel rotational axis in the longitudinal direction to a location behind the front wheel rotational axis in the longitudinal direction. A front camera can be located on the front arcuate trim piece and a front spray nozzle located adjacent the front camera on the front arcuate trim piece.

Some embodiments are directed to a vehicle trim having a camera and wash system for use on a vehicle. The vehicle can have a longitudinal direction and a transverse direction perpendicular to the longitudinal direction of the vehicle, the vehicle including a front wheel and a rear wheel spaced from the front wheel along the longitudinal direction of the vehicle. The front wheel has a rotational axis and the rear wheel has a rotational axis. The vehicle can include a front fender defining a front wheel arch adjacent the front wheel and extending around a portion of the rotational axis of the front wheel. The vehicle trim can include a front arcuate plastic molded body configured to be connected to the front fender along the front wheel arch, the front arcuate plastic molded body extending in an arch shape. A front camera can be located on the front arcuate plastic molded body and a front spray nozzle can be located adjacent the front camera on the front arcuate plastic molded body. A rear camera can be located on the front arcuate plastic molded body and a rear spray nozzle can be located adjacent the rear camera on the front arcuate plastic molded body. The front camera can include a lens having a first optical axis and the rear camera can include a lens having a second optical axis, the first optical axis forming an angle greater than zero with respect to the second optical axis.

Some embodiments are directed to a vehicle trim, for use on a vehicle having a longitudinal direction extending in a drive direction of the vehicle and a transverse direction perpendicular to the longitudinal direction of the vehicle. The vehicle can include a front wheel and a rear wheel spaced from the front wheel along the longitudinal direction of the vehicle. The front wheel can have a rotational axis and the rear wheel can have a rotational axis. The vehicle trim can include a front fender defining a front wheel arch adjacent the front wheel and extending around a portion of the rotational axis of the front wheel. A front arcuate trim piece can be connected to the front fender along the front wheel arch, the trim piece extending about the front wheel arch from a location in front of the front wheel rotational axis in the longitudinal direction to a location behind the front wheel rotational axis in the longitudinal direction. A front camera can be located on the front arcuate trim piece and a front spray nozzle can be located adjacent the front camera on the front arcuate trim piece. A rear camera can be located on the front arcuate trim piece and a rear spray nozzle can be located adjacent the rear camera on the front arcuate trim piece. The front camera can include a lens having a first optical axis and the rear camera can include a lens having a second optical axis, the first optical axis forming an angle greater than zero with respect to the second optical axis.

### BRIEF DESCRIPTION OF THE DRAWINGS

The disclosed subject matter of the present application will now be described in more detail with reference to exemplary embodiments of the apparatus and method, given by way of example, and with reference to the accompanying drawings, in which:

FIG. 1A is a perspective view of a vehicle made in accordance with principles of the disclosed subject matter.

FIG. 1B is a close-up view of the trim and fender of the vehicle of FIG. 1.

FIG. 2 is a side view of a vehicle made in accordance with principles of the disclosed subject matter.

FIG. 3 is a schematic cross-sectional view of a front fender and trim made in accordance with principles of the disclosed subject matter.

### DETAILED DESCRIPTION OF EXEMPLARY EMBODIMENTS

A few inventive aspects of the disclosed embodiments are explained in detail below with reference to the various figures. Exemplary embodiments are described to illustrate the disclosed subject matter, not to limit its scope, which is defined by the claims. Those of ordinary skill in the art will recognize a number of equivalent variations of the various features provided in the description that follows.

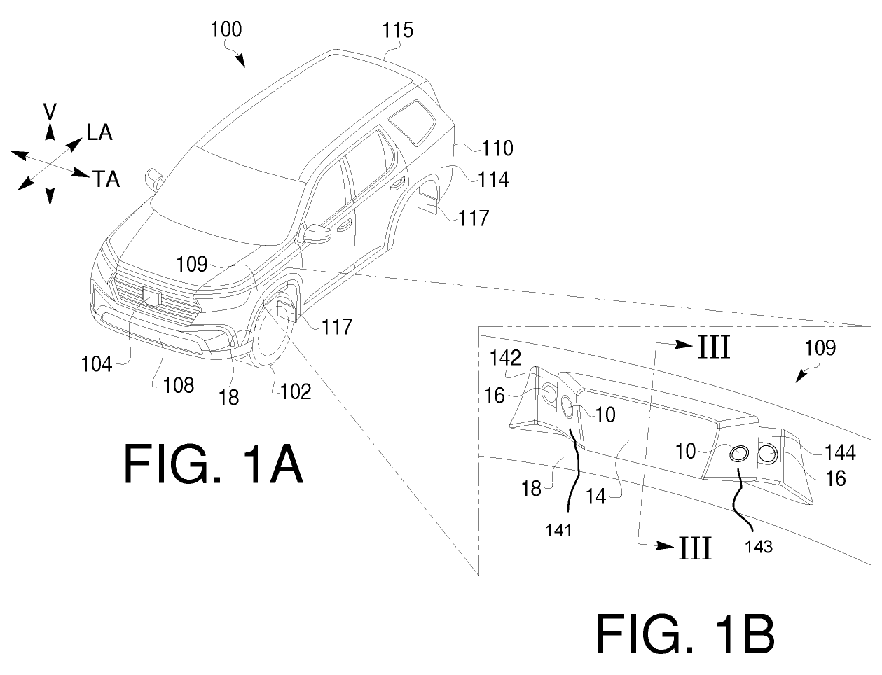

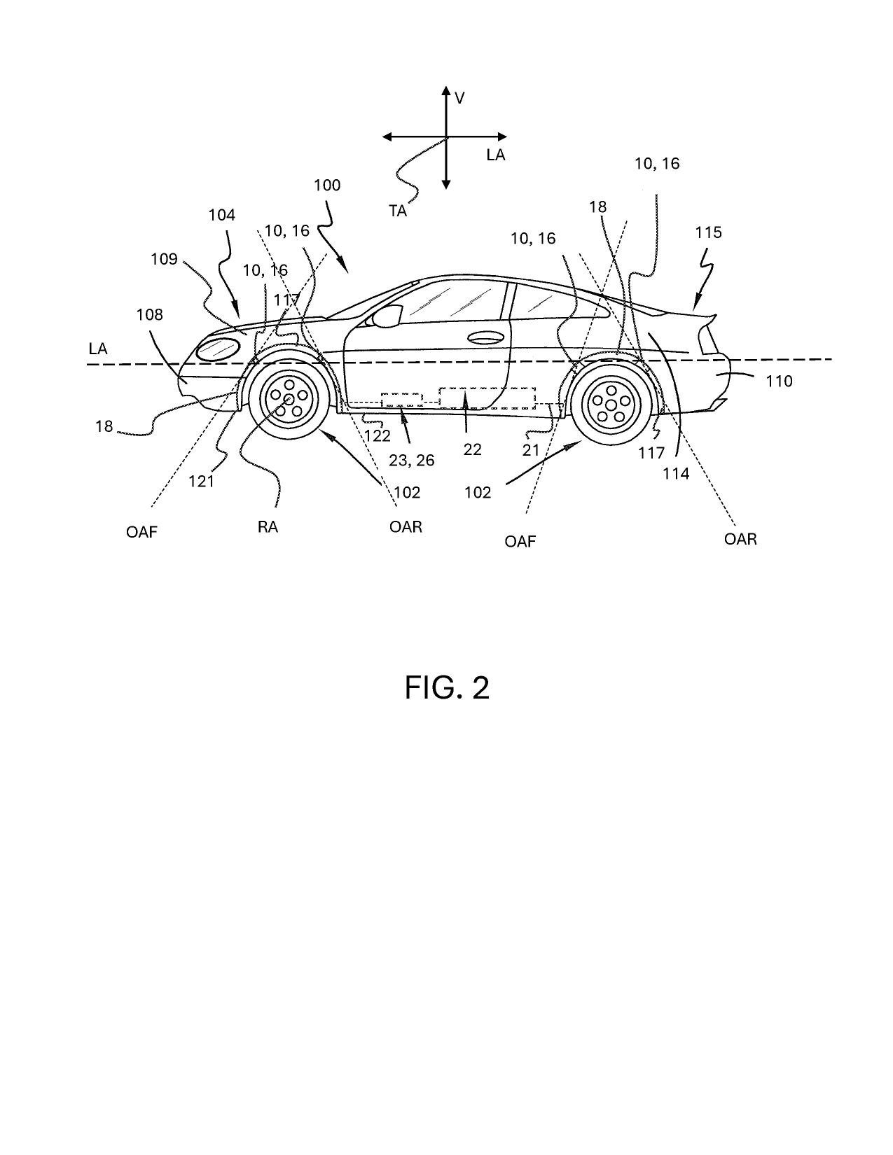

FIG. 1A depicts an example of a vehicle 100 made in accordance with principles of the presently disclosed subject matter. The vehicle 100 can include a camera 10 and wash system 26 (see FIG. 2) built into the trim 18 and wheel arch(s) 117 of the vehicle 100.

The vehicle 100 can include a front bumper 108 located at a front 104 of the vehicle 100, and a rear bumper 110 located at a rear 115 of the vehicle. The front bumper 108 and rear bumper 110 can be located at opposite ends of the vehicle 100 and spaced along a longitudinal direction L of the vehicle 100. The longitudinal direction L of the vehicle 100 can also be considered the driving direction of the vehicle.

A wheel 102 can be located in each wheel arch 117 defined by the front fender 109 and rear fender 114, respectively. Each wheel 102 can include a rotational axis RA that, as shown in the embodiment depicted in FIG. 2, is perpendicular to the longitudinal direction L and the vertical direction V of the vehicle 100. A trim piece 18 can be attached to the wheel arch 117 and extend in a mating arch-like configuration with respect to the wheel arch 117. For example, in the embodiment shown in FIG. 1, the trim piece 18 extends over 180 degrees of a semicircle that is centered substantially at the rotational axis RA of the wheel 102. The trim piece 18 need not (but can be) semi-circular. The trim piece 18 can alternatively be made up of a series of arches that are connected together in segments that extend around the tire 102 and about the wheel arch 117 of fender 109. The trim piece 18 can also be a non-symmetrical free-form shape that is generally arched in nature, conforming with the geometry of the wheel arch 117. Typically, the trim piece 18 can extend from a point in front of the rotational axis RA of the wheel 102 (in the longitudinal direction L) to a point rearward of the rotational axis RA of the wheel 102 (in the longitudinal direction L). For example, the trim piece 18 can extend from a first point both in front of the rotational axis RA of the wheel 102 (in a longitudinal direction L) and below the rotational axis RA of the wheel 102 (in the vertical direction). The trim piece 18 can extend upward from the first point to a location above the rotational axis (in the vertical direction) and then continue to extend rearward and downward to a point behind the rotational axis RA of the wheel 102 (in the longitudinal direction L) and finally to a second point where the trim piece 18 terminates located both behind the rotational axis RA of the wheel 102 (in the longitudinal direction L) and below the rotational axis RA of the wheel 102 (in the vertical direction). Thus, the trim piece 18 can traverse an arch that is greater than 180 degrees about the rotational axis RA of the wheel 102. Alternatively, the trim piece 18 can also be located entirely above the rotational axis RA of the wheel (in the vertical direction V) such that the trim piece 18 follows the wheel arch 117 and extends about an arch that is less than 180 degrees substantially about the rotational axis RA of the wheel 102. The length of the trim piece 18 can be determined by design requirements or can be a function of protecting a portion of or the entire extent of the wheel arch 117 of fender 109 about the wheel 102. The trim piece 18 could also have a front end point located below the rotational axis RA of the wheel 102 (in the vertical direction) and a rear end point above the rotational axis RA of the wheel 102 (in the vertical direction), or vice versa.

The front fender 109 can be made from a metal material, such as steel, aluminum, metal compounds and/or metal alloys. The trim piece 18 can be a different material, such as a plastic, a rubber, a ceramic piece, etc. However, it is contemplated that both the fender 109 and trim piece 18 could be made from the same material in certain applications.

While the above description is directed to the relationship between the front fender 109 and trim piece 18, the disclosure is also related to and equally applicable to the rear fender 114 and trim piece 18 attached to the rear fender 114. The descriptions are also related to and equally applicable to either the right or left side portions (fenders, trim pieces, cameras, wash systems, etc.) of the vehicle.

FIG. 1B shows a close up view of a portion of the trim piece 18 and fender 109 of FIG. 1A. In this view, a pair of cameras 10 can be seen located at either side of a camera housing 14 of the trim piece 18 and facing away from each other. A nozzle 16 can be located in a rear wall / concave indent 144 such that the nozzle 16 faces towards a rear camera 10 located on the rear angled wall 143 of camera housing 14. A front wall / concave indent 142 can be formed at an opposite end of the camera housing 14 as compared to the rear wall / concave indent 144. A second nozzle 16 can be located in the front wall / concave indent 142 and face towards a front camera 10. Each nozzle 16 can have a spray axis along which fluid is directed outward of the nozzle 16 and towards a lens 12 of each camera 10. The front camera 10 can be located on a front angled wall 141 of the camera housing 14 that is angled with respect to a floor and/or angled front wall / concave indent 142. The angled front wall / concave indent 142 can be adjacent the camera housing 14 and located closer to a front of the vehicle in the longitudinal direction LA as compared to the angled rear wall / concave indent 144. Of course, it is not necessary to include concave indents 142, 144 in the front/rear walls. Instead, the front/rear camera(s) 10 and front/rear nozzle(s) 16 can be located on a flat portion (continuous flat surface) of the trim piece(s) 18, or on an elevated surface above the continuous flat surface of the trim piece(s) 18. Furthermore, although the drawings show the camera 10 and nozzle 16 on surfaces at an obtuse or possibly acute angle facing each other, the architecture of the camera housing 15 and trim piece 18 can substantially vary and remain within the scope of the disclosed subject matter. For example, the surface on which the camera 10 and nozzle 16 are located can be curved, can be a continuous surface, and/or can be separate and distinct surfaces. The locations of the camera 10 and nozzle 16 can be reversed, and for example, a front camera 10 can be oriented in a manner to view a rear portion behind the wheel associated with the camera 10, and a rear camera 10 can be oriented in a manner to view a front portion in front of the wheel associated with the camera 10, and vice-versa. Further, the camera 10 can be positioned so that its optical axis points sideways (in a transverse direction away from the vehicle) or can be positioned such that the optical axis points downward (for example in a transverse and vertical direction, or in solely vertical direction, or any angle relative to each of the transverse, longitudinal and vertical directions associated with the vehicle). The optical axis of the camera 10 can also be positioned soas to intersect the rotational axis of the associated wheel while the camera 10 is positioned at, in front, or behind the rotational axis of the associated wheel in the longitudinal direction of the vehicle. The described positions of the camera 10 on the vehicle, and any combinations of these positions are contemplated for use in the presently disclosed subject matter, and the same positions and orientations are contemplated for use by the nozzle 16 (for example, the nozzle 16 can be oriented to spray in any of a 0-360 degree angle when located at any position about a 360 arc around a respective camera 10. The trim piece 18 is shown as made from a single integral and continuous material. However, the trim piece 18 can be formed from multiple parts such that each camera 10 can be located in a single portion of the trim piece 18, while each nozzle 16 is located in another material portion of the trim piece 18 that can be separate from and distanced from the portion of the trim piece 18 in which the camera 10 is located.

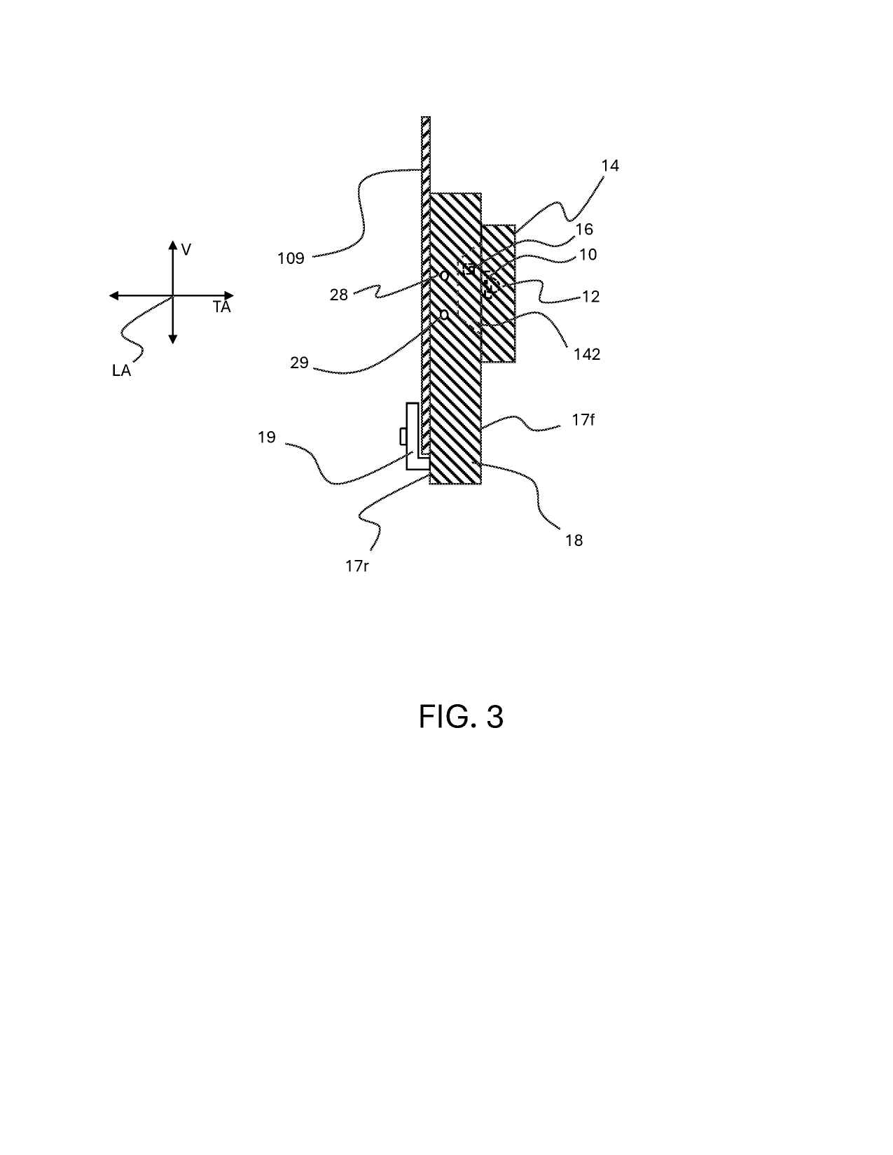

Returning to the exemplary embodiment shown in FIGS. 1A and B, a rear camera 10 can be located on a rear wall 143 of the camera housing 14. The rear wall 143 of the camera housing 14 can be at an angle (greater than zero) with respect to the rear wall of the concave indent 144 such that an optical axis OAR (see FIG. 2) of the rear camera 10 is angled with respect to both the front surface / side 17f (see FIG. 3) of the trim piece 18 and the rear wall and floor of the concave indent 144. In addition, the front wall 141 of the camera housing 14 can be configured such that an optical axis OAF (see FIG. 2) of the front camera 10 extends frontward and to a side of the vehicle 100. In other words, the front wall 141 can be configured such that the optical axis OAF of the front camera 10 is directed frontward and downward (as viewed from a side of the vehicle 100) and in an outward transverse direction T of the vehicle 100. By contrast, the rear wall 142 of the camera housing 14 can be configured such that an optical axis OAR of rear camera 10 (located in the rear wall 142) extends downward and rearward to a side of the vehicle 100. In other words, the rear wall 142 can be configured such that the optical axis OAR of the rear camera 10 located thereon is directed rearward and downward and in an outward transverse direction T of the vehicle 100. Thus, from a side view of the vehicle 100, the optical axis OAF of the front camera 10 located on front wall 141 will appear to intersect with the optical axis OAR of the rear camera 10 at a point behind and above the trim piece 18. The optical axis OAF of the camera 10 located on the front wall 141 can be at an angle alpha greater than zero with respect to the optical axis OAR of the camera 10 located on the rear wall 143 as viewed from a side of the vehicle 100 (along the transverse direction T, as shown in FIG. 2). The angle alpha can be anywhere from 1 -180 degrees, such that the optical axes OAF, OAR of the two cameras 10 located in the trim piece 18 appear to intersect with each other as viewed from the side of the vehicle 100. Thus, when an appropriate wide angle lens 12 is selected, the cameras 10 can provide a full view along the side of the vehicle 100 for use with a controller 22.

Fig, 2 depicts a side view of another vehicle 100 made in accordance with principles of the disclosed subject matter. The vehicle can include a controller 22 that can be the vehicle’s electronic control unit (ECU) or can be a portion of the ECU, or can be a separate controller, that includes hardware and/or software that allows it to use the data received from the cameras 10 to affect vehicle action(s). For example, the controller 22 can be configured to receive data from each camera 10 and determine from that data whether an obstruction such as dirt, rain, road wash, fogging, or other detritus is causing the camera 10 to function at a lower level or lower accuracy. If such obstruction data from the camera(s) 10 is received and determined through analysis to exist, the controller 22 can be configured to then initiate vehicle actions, such as actuating pump 23 to eject fluid (e.g., water, antifreeze, ammonia, cleaner, etc.) from nozzle 16 to clean the lens 12 (see FIG. 3) of camera 10. Alternatively, the vehicle actions can be selected from the following exemplary group of actions: actuating a motor on a wiper that can be included in the wash system 26; providing a notice or warning to the driver to clean the camera 10 and lens 12; de-activating certain aspects of an autonomous driving system; actuating a heater associated with the camera 10 and/or lens 12 to de-fog and/or clean the lens 12 and camera 10; actuating a motor to move camera 10 and/or lens to a desired position; actuating a motor to move camera 10 and/or lens 12 through a wash system such as a wiper or sponge located adjacent the camera 10; actuating a motor to move camera 10 and/or lens 12 to a safe /protected location away from outside elements (e.g., within a housing) while the vehicle 100 is at rest or when autonomous driving is not desired or when high level of water or debris is anticipated; actuating a motor to move a cover over camera 10 and/or lens 12 to protect the camera 10 and/or lens 12 from outside elements while the vehicle 100 is at rest or when autonomous driving is not desired or when the vehicle 100 is in a situation where a high level of water or debris is anticipated to contact the camera 10 and/or lens 12.

A pump 23 with reservoir (along with the controller 22) can be located within the body of the vehicle 100 to form the wash system 26 for washing the camera 10 and/or lens 12 when it is determined that an obstruction such as dirt or other visual impairment is located on or at the camera 10 and/or lens 12. The controller 22 can be connected to the camera 10 or wash system 26 via line 21. The line 21 can be a physical electrical / communication wire or can be a wireless connection between one or all components, such as the controller 22, pump 23, wash system 26, and camera 10. In certain cases, the controller 22 could be located outside of the vehicle body and communicate with the vehicle 100 and its components via internet, cellular, Bluetooth, or other connection communication protocol.

The trim piece 18 in both the front fender 109 and rear fender 114 can extend about an entire periphery of the wheel arch 117 so as to protect the front fender 109 and/or rear fender 114 from the elements (from wear and tear) and to provide a smooth aesthetic for the vehicle 100. For example, the trim piece 18 can extend from a lowermost surface (e.g., lowermost surface 121 in vertical direction V of front fender 109 or front bumper panel 108) upward and around the wheel arch 117 to a second lowermost surface (e.g., lowermost surface 122 in vertical direction V of a side panel of vehicle). Alternatively, the trim piece 18 can extend about a lesser extent of the wheel arch 117. For example, the trim piece 18 can extend about an angle from 20 degrees to 180 degrees substantially about the rotational axis RA of the wheel 102. The trim piece 18 need not be centered about the rotational axis RA of each wheel 102, but can be offset from the rotational axis RA. The trim piece 18 can be symmetrical or non-symmetrical about the rotational axis RA itself, and can be symmetrical or non-symmetrical about a vertical line extending from the rotational axis RA.

FIG. 3 is a schematic cross-sectional view taken along line III-III of FIG. 1B of a front fender 109 and trim piece 18 made in accordance with principles of the disclosed subject matter. The trim piece 18 has a front surface 17f that faces away from the vehicle 100 in the transverse direction T and a rear surface 17r that faces inwardly towards the vehicle 100 in the transverse direction T. An attachment structure 19 is located at the rear surface 17r such that the trim piece 18 can be attached to the fender 109. In particular, the fender 109 can be in contact with and run along at least a portion of the rear surface 17r of the trim piece 18. The attachment structure 19 can be a clip, a bolt, a rivet, a clamp, a press fit, an adhesive, a weld, or other structure that can mount the trim piece 18 to the fender 109 along the wheel arch 117.

The trim piece 18 can include a camera housing 14 that houses each camera 10 and lens 12. The wash system 26 including the nozzle 16 can be located immediately adjacent the camera housing 14. A fluid line 28 can run within or behind the trim piece 18 and communicate fluid from the pump 23 to the nozzle 16 of wash system 26. The fluid line 28 can be a separate hose or conduit, or can be a channel molded into the trim piece 18. A reservoir of fluid (such as water, antifreeze, cleaning fluid, ammonia, or the like) can be located within the vehicle 100 and can be associated with the pump 23 and nozzle 16 via fluid line 28. For example, the pump 23 could be connected to the windshield wiper fluid reservoir of vehicle 100, or to a separate camera cleaning fluid reservoir to supply fluid to the nozzle 16.

A communication line 29 can also run within or behind the trim piece 18 to provide a communication channel between the camera 10 and the controller 22. The line 29 can be an electric wire that is connected to a rear surface 17r of the trim piece or can be an electric wire molded into the trim piece 18.

While certain embodiments of the invention are described above, it should be understood that the invention can be embodied and configured in many different ways without departing from the spirit and scope of the invention. Although the components of the camera 10, lens 12, and wash system 26 including the nozzle 16 are shown as embedded within the camera housing 14 and trim piece 18, it should be understood that any one or all of these components need not be buried but could be mounted, adhered or otherwise attached on a top surface of trim piece 18, such as on the front side 17f. In addition, the trim piece 18 could be made thicker in the transverse direction and both the camera 10 and nozzle could be located within an indent (or indents) that extend into the trim piece 18. The trim piece 18 can be a unitary single material integral structure that extends around a majority of the rotational axis of the wheel 102. Alternatively, the trim piece 18 could be a multi piece structure that is assembled about the wheel arch 117 of the vehicle 100.

The disclosed subject matter relates to a vehicle 100 and trim 18 including camera 10 and washing system 26 for a level 3 autonomous driving vehicle in which conditional driving automation is present. For example, for use in a system that allows a vehicle to perform some driving tasks (and monitors certain environmental conditions) while the driver remains in the seat and ready to take control. However, the disclosed subject matter could be used in vehicles having other levels of autonomous driving, including any of levels 0-5.

While the disclosed embodiments show the cameras 10 each having an optical axis pointing outward and downward from the trim piece 18, it is contemplated that the camera(s) 10 (all or a number thereof) could have an optical axis that is directed upward (relative to the vertical direction and away from the rotational axis RA) if data related to an upper side view is desired. The focal length of the front camera 10 can be different from the focal length of the rear camera 10 on each trim piece 18 so as to provide the controller 22 with data that covers more volume of space (to monitor more area at the side of the vehicle 100). This differences in focal length can be accomplished by providing different lenses 12, or can be controlled electronically within the camera 10 itself. Similarly, the position of each camera 10 and related optical axis positions can be changed from those disclosed above and shown in the related figures without departing from the spirit of the disclosed subject matter. For example, the optical axis of the front camera 10 could extend rearward and the optical axis of the rear camera 10 could extend frontward in various combinations depending on what data is desired to be collected and used by the controller 22.

In another embodiment, the controller 22, which can be the vehicle ECU, receives data from the front camera, the rear camera, and a series surround cameras on the vehicle, and then based on each camera’s calculated or viewed “debris amount,” the controller 22 will activate the cleaning system to clean each camera separately and/or together, for example, by spraying a cleaning fluid from one or more of the nozzle(s) 16 can be adjacent the camera(s).

The lens 12 disclosed above can be a concave lens, convex lens, and can further be a compound lens, meniscus type lens(es), double concave, double convex, planar concave, planar convex as well as other type(s) of lens(es) depending on the particular application and range of focus desired.

The disclosed subject matter can be directed to embodiments in which a varying number of camera(s) 10 and nozzle(s) 16 are located in different positions within or adjacent the trim 18. For example, a single camera, single camera with nozzle, two cameras, two cameras with respective washer nozzles, and swapping front and rear camera locations are all considered within the scope of the presently disclosed subject matter.

The communication line 29 described above is disclosed as a metal/electric wire. However, a fiber optic cable or other means for communicating information from the camera 10 to the controller 22 can be used, including wireless communications as described above. In addition, the controller 22 could be combined with the camera 10 and located / integrated into the trim piece 18. Thus, decisions related to whether to wash the camera 10 can be made at the camera itself either in isolation from or in conjunction with operation / functioning of the vehicle’s main ECU.

The subject matter has been described in detail with reference to exemplary embodiments thereof. However, it will be apparent to one skilled in the art that various changes can be made, and equivalents employed, without departing from the scope of the invention, as defined by the claims appended hereto.

What is claimed is:

1. A vehicle having a camera and wash system, comprising:
a vehicle having a longitudinal direction and a transverse direction perpendicular to the longitudinal direction of the vehicle, the vehicle including a front wheel and a rear wheel spaced from the front wheel along the longitudinal direction of the vehicle, the front wheel having a rotational axis and the rear wheel having a rotational axis;
a fender defining a wheel arch adjacent at least one of the front wheel and rear wheel, and extending around a portion of a respective rotational axis;
a trim piece connected to the fender along the wheel arch, the trim piece extending about the wheel arch from a location in front of the respective rotational axis in the longitudinal direction to a location behind the respective rotational axis in the longitudinal direction;
a camera located on the trim piece and a spray nozzle located adjacent the camera on the trim piece.

2. The vehicle according to claim 1, wherein the trim piece is a plastic material and the fender is a metal material, and the trim piece arcuately extends more than 30 degrees about the rotational axis.

3. The vehicle according to claim 1, further comprising:
a second camera located on the trim piece and a second spray nozzle located adjacent the second camera on the trim piece.

4. The vehicle according to claim 3, wherein the camera and spray nozzle are located at a frontward side of the respective rotational axis in the longitudinal direction of the vehicle, and the second camera and second spray nozzle are located at a rearward side of the respective rotational axis in the longitudinal direction of the vehicle such that that respective rotational axis is located between the camera and the second camera in the longitudinal direction of the vehicle.

5. The vehicle according to claim 4, wherein the camera includes a lens having a first optical axis and the second camera includes a lens having a second optical axis, the first optical axis forming an angle greater than zero with respect to the second optical axis.

6. The vehicle according to claim 1, wherein the camera is located on a first portion of the trim piece, and the spray nozzle is located on a second portion of the trim piece, and the first portion of the trim piece is separate from and spaced from the second portion of the trim piece.

7. The vehicle according to claim 1, further comprising:
a lens located adjacent the camera, and configured such that the camera provides a view of an exterior of the vehicle; and
a controller configured to receive data from the camera and determine from the data whether debris is located on the lens, and if a determination is made that debris is located on the lens, to actuate a pump to cause a fluid to be ejected from the spray nozzle to clean the lens.

8. The vehicle according to claim 6, further comprising:
a pump connected to the spray nozzle and configured to cause a fluid to be ejected from the spay nozzle to clean the lens.

9. The vehicle according to claim 1, wherein the fender is a front fender, and the vehicle further comprises:
a rear fender defining a rear wheel arch adjacent a rear wheel;
a rear trim piece connected to the rear fender along the rear wheel arch, the rear trim piece extending about the rear wheel arch from a location in front of the rear wheel rotational axis in the longitudinal direction to a location behind the rear wheel rotational axis in the longitudinal direction; and
a first rear camera located on the rear trim piece and a first rear spray nozzle located adjacent the first rear camera on the rear trim piece.

10. A vehicle trim having a camera and wash system for use on a vehicle, the vehicle having a longitudinal direction and a transverse direction perpendicular to the longitudinal direction of the vehicle, the vehicle including a front wheel and a rear wheel spaced from the front wheel along the longitudinal direction of the vehicle, the front wheel having a rotational axis and the rear wheel having a rotational axis, the vehicle including a fender defining a wheel arch adjacent one of the front wheel and rear wheel, and extending around a portion of a respective one of the front rotational axis and rear wheel axis, the vehicle trim comprising:
an arcuate plastic molded body configured to be connected to the fender along the wheel arch, the arcuate plastic molded body extending in an arch shape;
a first camera located on the arcuate plastic molded body and a first spray nozzle located adjacent the first camera on the arcuate plastic molded body;
a second camera located on the arcuate plastic molded body and a second spray nozzle located adjacent the second camera on the arcuate plastic molded body, wherein
the first camera includes a lens having a first optical axis and the second camera includes a lens having a second optical axis, the first optical axis forming an angle greater than zero with respect to the second optical axis.

11. The vehicle trim according to claim 10, wherein the first camera lens is a convex lens.

12. The vehicle trim according to claim 10, further comprising:
a controller configured to receive data from the first camera and determine from the data whether debris is located on the lens of the first camera, and if a determination is made that debris is located on the lens of the first camera, to actuate a pump to cause a fluid to be ejected from the first spray nozzle to clean the lens of the first camera.

13. The vehicle trim according to claim 10, further comprising:
a pump connected to the first spray nozzle and configured to cause a fluid to be ejected from the first spay nozzle to clean the lens of the first camera.

14. The vehicle trim according to claim 10, wherein the arcuate plastic molded body includes attachment structure for connecting to the fender, and the attachment structure is located on a side of the arcuate plastic molded body opposite to a side upon which the first camera and the first spray nozzle are located on the arcuate plastic molded body.

15. A vehicle trim, for use on a vehicle having a longitudinal direction extending in a drive direction of the vehicle and a transverse direction perpendicular to the longitudinal direction of the vehicle, the vehicle including a front wheel and a rear wheel spaced from the front wheel along the longitudinal direction of the vehicle, the front wheel having a rotational axis and the rear wheel having a rotational axis, the vehicle trim comprising:
a fender defining a wheel arch adjacent one of the front wheel and rear wheel, and extending around a portion of a respective rotational axis of one of the front wheel and rear wheel;
a trim piece connected to the fender along the wheel arch, the trim piece extending about the wheel arch from a location in front of the respective rotational axis in the longitudinal direction to a location behind the respective rotational axis in the longitudinal direction; and
a first camera located on the trim piece.

16. The vehicle trim according to claim 15, further comprising:
a first spray nozzle located adjacent the first camera on the trim piece;
a second camera located on the trim piece and a second spray nozzle located adjacent the second camera on the trim piece, wherein
the first camera includes a lens having a first optical axis and the second camera includes a lens having a second optical axis, the first optical axis forming an angle greater than zero with respect to the second optical axis, and
the trim piece is a plastic material and the fender is a metal material.

17. The vehicle trim according to claim 15, wherein the first camera and first spray nozzle are located at a frontward side of the respective rotational axis in the longitudinal direction of the vehicle, and the second camera and second spray nozzle are located at a rearward side of the respective rotational axis in the longitudinal direction of the vehicle such that that respective rotational axis is located between first camera and second camera in the longitudinal direction of the vehicle.

18. The vehicle trim according to claim 15, further comprising:
a controller configured to receive data from at least one of the first camera and second camera, and determine from the data whether debris is located on the lens of a respective one of first camera and second camera, and if a determination is made that debris is located on the lens, to actuate a pump to cause a fluid to be ejected from at least a respective one of the first spray nozzle and second spray nozzle to clean the lens.

19. The vehicle trim according to claim 15, wherein the trim piece is a molded plastic structure that includes a camera housing having a front angled wall, a rear angled wall, and a top surface located between and spacing the front angled wall from the rear angled wall, the first camera is located in the front angled wall, and the second camera is located in the rear angled wall.

20. The vehicle trim according to claim 15, wherein the first optical axis and second optical axis are angled with respect to each other such that data from each of the first camera and second camera support an autonomous drive system associated with the vehicle.
